(19) United States
(12) Patent Application Publication
(10) Pub. No.: US 2026/0121752 A1
(43) Pub. Date: Apr. 30, 2026

(54) TIME-MULTIPLEXED MULTI-FUNCTIONAL COHERENT OPTICAL TRANSCEIVER

(71) Applicant: Raytheon Company, Tewksbury, MA (US)

(72) Inventors: Fabio Di Teodoro, Hacienda Heights, CA (US); Joseph Marron, Manhattan Beach, CA (US)

(21) Appl. No.: 18/930,778

(22) Filed: Oct. 29, 2024

(51) Int. Cl. H04B 10/40; H04B 10/50

(52) U.S. Cl. CPC H04B 10/40; H04B 10/503

(57) ABSTRACT

An optical transceiver includes a fiber-laser transmitter configured to transmit a transmit beam toward a target and transmitter optics optically coupled to the fiber-laser transmitter. The optical transceiver also includes an optical receiver configured to receive a return beam and an adaptive active modifier optically coupled to the optical receiver. The optical transceiver further includes a local oscillator optically coupled to the optical receiver and adaptive active modifier. In addition, the optical transceiver includes at least one processing device coupled to the fiber-laser transmitter and adaptive active modifier. The at least one processing device is configured to cause the optical transceiver to turn off the local oscillator during an initial time interval, emit a stream of laser pulses using the fiber-laser transmitter during the initial time interval toward the target, measure the return beam, and determine a translational velocity of the target.

### TECHNICAL FIELD

This disclosure relates generally to optical systems and processes. More specifically, this disclosure relates to a time-multiplexed multi-functional coherent optical transceiver.

### BACKGROUND

The effectiveness of various optical systems (such as those used in directed-energy, remote sensing, and free-space optical communication applications) typically rests on multiple lasers performing coordinated and synergistic functions. For example, a high-energy laser may be assisted by a target-tracking illuminator and a beacon illuminator, which may respectively support aimpoint and adaptive-optics tasks. The accumulation of specialized laser-based subsystems in these or other applications undesirably inflates a platform's size, weight, power, and cost (SWAP-C) and adds significant complexity in the optical design, including the need for customized spectrally-discriminating dichroic or dispersive elements. Moreover, traditional transceivers are often plagued by one or more outstanding problems that impair or limit performance but are inherently difficult to solve within traditional architectures.

### SUMMARY

This disclosure relates to a time-multiplexed multi-functional coherent optical transceiver.

In some examples, an optical transceiver may include a fiber-laser transmitter configured to transmit a transmit beam toward a target and transmitter optics optically coupled to the fiber-laser transmitter. The optical transceiver may also include an optical receiver configured to receive a return beam and an adaptive active modifier optically coupled to the optical receiver. The optical transceiver may further include a local oscillator optically coupled to the optical receiver and the adaptive active modifier. In addition, the optical transceiver may include at least one processing device coupled to the fiber-laser transmitter and the adaptive active modifier. The at least one processing device may be configured to cause the optical transceiver to turn off the local oscillator during an initial time interval, emit a stream of laser pulses using the fiber-laser transmitter during the initial time interval toward the target, measure the return beam, and determine a translational velocity of the target.

Any single one or any combination of the following features may be used with the examples above. The at least one processing device may be configured to cause the optical transceiver, after determining the translational velocity of the target during the initial time interval, to turn on and frequency-shift the local oscillator using an offset frequency equal to a Doppler shift of the target for a subsequent time interval. The at least one processing device may be configured, after determining the translational velocity of the target during the initial time interval, to generate spatial imaging for a subsequent time interval. The at least one processing device may be configured to cause the optical transceiver to generate a non-periodic sequence of laser pulses using the fiber-laser transmitter during the initial time interval, determine a target range using a maximum of a cross-correlation between the non-periodic sequence of laser pulses and detected return arrival times of received pulses, and use the determined target range to determine a duration to have the local oscillator turned on. The at least one processing device may be configured to use the determined target range to determine a timing of an emission of a local oscillator beam from the local oscillator to the optical receiver. The optical transceiver may further include a sensor that includes an array of Geiger-mode avalanche photodiodes configured to timestamp each light detection event. The adaptive active modifier may include an acousto-optic variable frequency shifter and an electro-optic phase modulator.

In other examples, a system may include a high-energy laser system and an optical transceiver disposed within the high-energy laser system. The optical transceiver may include a fiber-laser transmitter configured to transmit a transmit beam toward a target and transmitter optics optically coupled to the fiber-laser transmitter. The optical transceiver may also include an optical receiver configured to receive a return beam and an adaptive active modifier optically coupled to the optical receiver. The optical transceiver may further include a local oscillator optically coupled to the optical receiver and the adaptive active modifier. In addition, the optical transceiver may include at least one processing device coupled to the fiber-laser transmitter and the adaptive active modifier. The at least one processing device may be configured to cause the optical transceiver to turn off the local oscillator during an initial time interval, emit a stream of laser pulses using the fiber-laser transmitter during the initial time interval toward the target, measure the return beam, and determine a translational velocity of the target.

Any single one or any combination of the following features may be used with the examples above. The at least one processing device may be configured to cause the optical transceiver, after determining the translational velocity of the target during the initial time interval, to turn on and frequency-shift the local oscillator using an offset frequency equal to a Doppler shift of the target for a subsequent time interval. The at least one processing device may be configured, after determining the translational velocity of the target during the initial time interval, to generate spatial imaging for a subsequent time interval. The at least one processing device may be configured to cause the optical transceiver to generate a non-periodic sequence of laser pulses using the fiber-laser transmitter during the initial time interval, determine a target range using a maximum of a cross-correlation between the non-periodic sequence of laser pulses and detected return arrival times of received pulses, and use the determined target range to determine a duration to have the local oscillator turned on. The at least one processing device may be configured to use the determined target range to determine a timing of an emission of a local oscillator beam from the local oscillator to the optical receiver. The optical transceiver may further include a sensor that includes an array of Geiger-mode avalanche photodiodes configured to timestamp each light detection event. The adaptive active modifier may include an acousto-optic variable frequency shifter and an electro-optic phase modulator.

In still other examples, a method may include initiating a first task in a first mode for an initial time interval using at least one processing device coupled to an optical transceiver. The optical transceiver may include a fiber-laser transmitter configured to transmit a transmit beam toward a target and transmitter optics optically coupled to the fiber-laser transmitter. The optical transceiver may also include an optical receiver configured to receive a return beam and an adaptive active modifier optically coupled to the optical receiver. The optical transceiver may further include a local oscillator optically coupled to the optical receiver and the adaptive active modifier. The method may also include initiating a second task in a second mode for a subsequent time interval using the optical transceiver.

Any single one or any combination of the following features may be used with the examples above. Initiating the first task in the first mode for the initial time interval may include turning off the local oscillator during the initial time interval, emitting a stream of laser pulses using the fiber-laser transmitter during the initial time interval toward the target, measuring a return beam using the sensor, and determining a translational velocity of the target based on the return beam. Initiating the second task in the second mode for the subsequent time interval may include, after determining the translational velocity of the target during the initial time interval, turning on and frequency-shifting the local oscillator using an offset frequency equal to a Doppler shift of the target for the subsequent time interval. Initiating the second task in the second mode for the subsequent time interval may include generating spatial imaging using the sensor. The method may include generating a non-periodic sequence of laser pulses using the fiber-laser transmitter during the initial time interval, determining a target range using a maximum of a cross-correlation between the non-periodic sequence of laser pulses and detected return arrival times of received pulses, and using the determined target range to determine a duration to have the local oscillator turned on. The method may include using the determined target range to determine a timing of an emission of a local oscillator beam from the local oscillator to the optical receiver.

Other technical features may be readily apparent to one skilled in the art from the following figures, descriptions, and claims.

### BRIEF DESCRIPTION OF THE DRAWINGS

For a more complete understanding of this disclosure, reference is made to the following description, taken in conjunction with the accompanying drawings, in which:

FIG. 1 illustrates an example system supporting a time-multiplexed multi-functional optical transceiver in accordance with this disclosure;

FIG. 2 illustrates an example architecture supporting a time-multiplexed multi-functional optical transceiver in accordance with this disclosure;

FIG. 3 illustrates an example device for a time-multiplexed multi-functional optical transceiver in accordance with this disclosure;

FIG. 4 illustrates an example schematic block diagram of a fiber-laser transmitter for supporting a time-multiplexed multi-functional coherent optical transceiver in accordance with this disclosure;

FIG. 5 illustrates an example mode of operation for supporting a time-multiplexed multi-functional coherent optical transceiver in accordance with this disclosure in accordance with this disclosure;

FIG. 6 illustrates an example portion of a time-multiplexed multi-functional coherent optical transceiver in accordance with this disclosure; and

FIG. 7 illustrates an example portion of a time-multiplexed multi-functional coherent optical transceiver in accordance with this disclosure.

### DETAILED DESCRIPTION

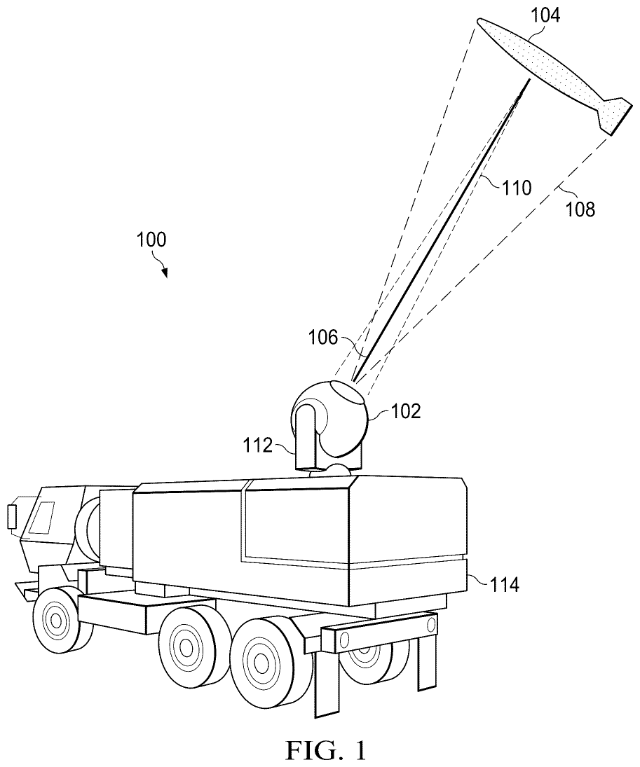

FIGS. 1 through 7, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, the effectiveness of various optical systems (such as those used in directed-energy, remote sensing, and free-space optical communication applications) typically rests on multiple lasers performing coordinated and synergistic functions. For example, a high-energy laser may be assisted by a target-tracking illuminator and a beacon illuminator, which may respectively support aimpoint and adaptive-optics tasks. The accumulation of specialized laser-based subsystems in these or other applications undesirably inflates a platform's size, weight, power, and cost (SWAP-C) and adds significant complexity in the optical design, including the need for customized spectrally-discriminating dichroic or dispersive elements. Moreover, traditional transceivers are often plagued by one or more outstanding problems that impair or limit performance but are inherently difficult to solve within traditional architectures.

Directed-energy weapon systems provide a specific example for at least one of these problems. It is well-known that a coherent approach to adaptive optics may surpass the performance of Shack-Hartmann wavefront sensing in the case of deep atmospheric turbulence. Among such coherent approaches is digital holography. In digital holography, an atmospheric aberration is probed by analyzing off-axis interference of a laser beam (usually referred to as a “beacon”) that has traveled to a target and back and thus experienced atmosphere-induced aberrations with a pristine reference sample of the same beam. A spatial fast Fourier transform of the obtained two-dimensional interference pattern can be computationally processed to yield a complex optical field of the target-reflected beacon returns, which permits the unambiguous reconstruction of their aberrated wavefront regardless of atmospheric conditions. By contrast, Shack-Hartmann wavefront sensors fail to reconstruct a propagating-beam wavefront when used in the frequently-encountered atmospheric regime of deep turbulence, characterized by moderate to high scintillation. Scintillation is a turbulence-induced self-interference phenomenon, which causes an amplitude of a propagating beam to become zero at locations across the beam wavefront where Shack-Hartmann sensors misread phase information. Even digital holography falls short when a target is moving, since the corresponding Doppler shift introduces an unknown phase contribution across the beam wavefront.

Another example of a problem inherent in some traditional optical transceivers pertains to frequency-modulated continuous wave (FMCW) light detection and ranging (LIDAR). FMCW LIDAR transceivers direct a frequency-modulated CW laser beam toward a target and receive the back-reflected return in a coherent fashion (much like digital holography), namely by detecting interference between the return and a low-power sample of the emitted beam (often referred to as a “local oscillator” beam). For FMCW LIDAR to work properly, the transmitter laser should not exhibit any random optical-phase jumps along the path to the target and back. In other words, its coherence length typically needs to exceed the transceiver-target roundtrip length. At sufficiently long ranges (such as about 10 km or longer), this can prove very challenging to meet for practical single-frequency lasers.

This disclosure provides a time-multiplexed multi-functional coherent optical transceiver. In some embodiments, the optical transceiver may support a combined transceiver architecture and mode of operation that permits a reduction in platform size, weight, power, cost, and complexity by concentrating functionalities of all laser-based subsystems within a single transmitter-receiver pair. The optical transceiver may also solve outstanding problems in coherent detection applications in practical ways.

FIG. 1 illustrates an example system 100 supporting a time-multiplexed multi-functional optical transceiver in accordance with this disclosure. As shown in FIG. 1, the system 100 includes a high-energy laser system 102 that is being used to engage a target 104. The target 104 in this example represents a rocket or missile. However, the high-energy laser system 102 may be used with any other suitable targets, such as one or more targets on the ground, in the air, on the water, or in space. Also, the functionality of the time-multiplexed multi-functional optical transceiver described below may be used with any other suitable system for aiming or targeting purposes or other purposes.

The laser system 102 in this example generates a high-energy laser (HEL) beam 106, a target illumination laser (TIL) beam 108, and optionally a beacon illumination laser (BIL) beam 110. The HEL beam 106 represents a beam of laser energy that typically has a high power or energy level, such as at least about 10 kilowatts (kW) of power. Often times, the HEL beam 106 is ideally focused to as small an area as possible on the target 104, which is done in order to achieve the maximum possible effect on the target 104.

The TIL beam 108 represents a beam of laser energy that spreads out to illuminate part or all of the target 104. The TIL beam 108 typically has a much lower power or energy level compared to the HEL beam 106. Reflections of the TIL beam 108 off the target 104 can be received at the laser system 102 and used to capture images of the target 104. The images may be processed to perform super-resolution, automatic target aimpoint recognition, target tracking, or other functions. The images can also be processed to measure, for instance, the distance and angle of the target 104 relative to the laser system 102 or relative to a high-energy laser in the laser system 102. In some embodiments, the TIL beam 108 may represent a continuous wave 1567 nanometer (nm) laser beam, although other suitable longer or shorter wavelengths may be used for the TIL beam 108.

The BIL beam 110 represents a beam of laser energy that may be used to generate a more focused illumination spot or “see spot” on the target 104. In some cases, a particular intended location on the target 104 to be illuminated by the BIL beam 110 may be selected. For example, it may be predetermined to illuminate a particular feature on the nose of the target 104. The BIL beam 110 can be subject to optical turbulence in the atmosphere or other effects that create boresight error for the BIL beam 110. Thus, the actual location of the see spot on the target 104 may vary from the intended or expected location of the see spot, and the difference between the actual and intended/expected locations of the see spot can be used to determine the boresight error. Movement of the BIL beam 110 on the target 104 may be used as a proxy for movement of the HEL beam 106 on the target 104, so adjustments can be made to the HEL beam 106 and the BIL beam 110 to reduce or minimize the movement of the HEL beam 106 and the BIL beam 110 on the target 104. In some embodiments, the BIL beam 110 may represent a 1005 nm laser beam, although other suitable longer or shorter wavelengths may be used for the BIL beam 110. In some cases, the wavelength of the BIL beam 110 can be close to the wavelength of the HEL beam 106.

The BIL beam 110 can be offset (such as in angle) relative to the HEL beam 106 so that the BIL beam 110 and the HEL beam 106 strike the target 104 at different locations. However, both beams 106 and 110 travel from the laser system 102 to the target 104 in very close proximity to one another, and the actual distance between the strike points for the two beams 106 and 110 can be very small. Because of this, compensating for the boresight error associated with the BIL beam 110 may also correct for the same boresight error associated with the HEL beam 106. If the wavelength of the BIL beam 110 is close to the wavelength of the HEL beam 106, the two beams 106 and 110 can experience approximately the same boresight error.

In this particular example, the laser system 102 includes or is used with a multi-axis gimbal 112, which mounts the laser system 102 on a vehicle 114. The multi-axis gimbal 112 includes any suitable structure configured to point the laser system 102 in a desired direction. In some embodiments, the multi-axis gimbal 112 can rotate the laser system 102 about a vertical axis for azimuth control and about a horizontal axis for elevation control. However, any other suitable mechanisms for pointing the laser system 102 (such as about a single axis or multiple axes) may be used here. Also, in this particular example, the vehicle 114 on which the laser system 102 is mounted represents an armored land vehicle. However, the laser system 102 may be used with any other suitable type of vehicle (such as any other suitable land, air, water, or space vehicle), or the laser system 102 may be mounted to a fixed structure (such as a building).

Although FIG. 1 illustrates one example of a system 100 supporting a time-multiplexed multi-functional optical transceiver, various changes may be made to FIG. 1. For example, the laser system 102 may be used in any other suitable environments and for any other suitable purposes. Also, while shown here as being used to damage or destroy a moving target 104, the laser system 102 can be used in any number of other ways depending on the application. Further, as noted above, one or more time-multiplexed multi-functional optical transceivers may or may not involve the use of a high-energy laser system 102 or an HEL beam 106, a TIL beam 108, and/or a BIL beam 110.

There are various defense-related and commercial or other non-defense-related applications for high-energy laser systems or other systems that may benefit from the approaches described in this disclosure. For instance, in commercial mining applications like drilling, mining, or coring operations, a high-energy laser can be used to soften or weaken an earth bed prior to drilling, which may allow for fewer drill bit changes and extended lifetimes and reliabilities of drill bits. In remote laser welding, cutting, drilling, or heat-treating operations like industrial or other automation settings, a high-energy laser can be used to allow for the processing of thicker materials at larger working distances from the laser system while minimizing the heat-affected zone and maintaining vertical or other cut lines. This helps to support welding or cutting operations where proximity to the weld or cut site is difficult or hazardous and helps to protect the laser system and possibly any human operators from smoke, debris, or other harmful materials. In construction and demolition operations like metal resurfacing or deslagging, paint removal, and industrial demolition operations, a high-energy laser can be used to ablate material much faster and safer compared to conventional operations. As a particular example of this functionality, a high-energy laser can be used to support demolition of nuclear reactors or other hazardous structures, such as by cutting through contaminated structures like contaminated concrete or nuclear containment vessels or reactors from long distances. This avoids the use of water jet cutting or other techniques (which creates contaminated water or other hazardous waste) and provides improved safety (since human operators can remain farther away from contaminated structures being demolished). A number of additional applications are possible, such as with a high-energy laser in power beaming applications (where a beam is targeted to photovoltaic cells of remote devices to be recharged) or hazardous material applications (where a beam is used to heat and decompose hazardous materials into less harmful or non-harmful materials).

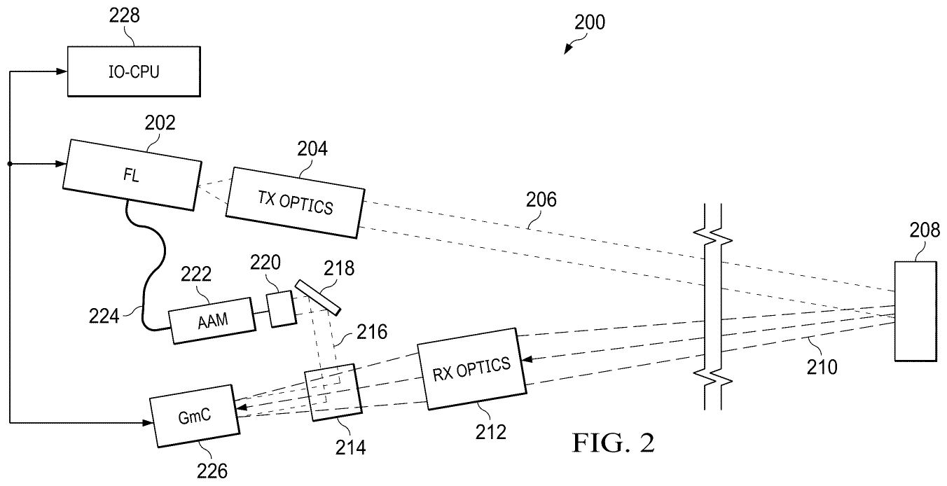

FIG. 2 illustrates an example architecture for an optical transceiver 200 for a time-multiplexed multi-functional coherent optical transceiver in accordance with this disclosure. For case of explanation, the architecture for the optical transceiver 200 may be described as being used in the system 100 of FIG. 1. However, the architecture for the optical transceiver 200 may be used in any other suitable device(s) and in any other suitable system(s).

As shown in FIG. 2, the optical transceiver 200 features a single-photon counting focal-plane detector and includes a fiber-laser transmitter 202. The fiber-laser transmitter 202 is optically coupled to transmitter optics 204 and is configured to direct a transmit beam 206 toward a target 208. A return beam 210 is backscattered or otherwise reflected from the target 208 and received for collection/measurement by an optical receiver 212. Here, the return beam 210 is directed toward local oscillator 214, which are optically coupled to the optical receiver 212. In some cases, the local oscillator 214 may split the return beam 210 and direct one portion of the return beam 210 towards a sensor 226. The local oscillator 214 may also use another portion of the split return beam 210 to produce and direct an expanded local oscillator beam 216 toward a local oscillator reflector 218 that sends the beam to a local oscillator expander 220. An adaptive active modifier 222 may receive the beam from the local oscillator expander 220 and transmit the beam back to the fiber-laser transmitter 202 using a delivery fiber 224. The operation of the optical transceiver 200 may be directed by a computing system 228 coupled to the fiber-laser transmitter 202 and the sensor 226.

In some embodiments, the transmit beam 206 and the return beam 210 may not share a common optical path, such as when a bi-static sensing configuration is used. In other embodiments, the transmit beam 206 and the return beam 210 may share at least a common fraction of their optical path, such as when a mono-static configuration is used. In these latter embodiments, polarization, time-domain, or other techniques may be used to support operation of the architecture for the optical transceiver 200. While not shown here, the optical receiver 212 may include components such as a light-collection pupil aperture and a beam-formatting telescope that focus collected light onto a focal-plane sensor or other sensor 226. In some cases, the optical receiver 212 may include optical components that spatially overlap and combine the return beam 210 with the beam emitted by the local oscillator at the sensor 226, such as by using a beam splitter.

In some embodiments, the sensor 226 may include an array of Geiger-mode avalanche-photodiodes configured to timestamp each light-detection event. For example, the sensor 226 may be a Geiger-mode camera. Also, in some embodiments, the sensor 226 may operate in an asynchronous mode in which each pixel of the sensing array reads light and refreshes independently. In particular embodiments, the sensor 226 beneficially provides single-photon sensitivity and fast response. Single-photon sensitivity may allow the transceiver to function without directing high-energy laser pulses to the target 208, which in turn permits use of fiber-laser transmitters 202. The fast response of the sensor 226 may afford a high rate of data processing, which can support time-multiplexed operation of the fiber-laser transceiver. As a particular example, each pixel of the sensor 226 may exhibit a response time faster than 1 ns for each incident photon and may reset or refresh for the next photon count in less than 1 μs, which supports operation with 1 MHz pulse repetition rates or even higher.

Although FIG. 2 illustrates one example of an architecture for an optical transceiver 200 for a time-multiplexed multi-functional coherent optical transceiver, various changes may be made to FIG. 2. For example, computing devices and systems come in a wide variety of configurations, and FIG. 2 does not limit this disclosure to any particular computing device or system.

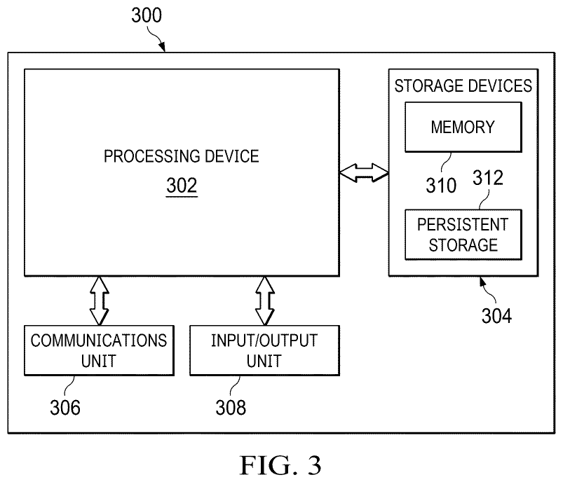

FIG. 3 illustrates an example device 300 for a time-multiplexed multi-functional coherent optical transceiver 200 according to the present disclosure. One or more instances of the device 300 (or portions thereof) may, for example, be used to at least partially implement the functionality of the optical transceiver 200 and/or the computing system 228 of FIG. 2. However, the functionality of the optical transceiver 200 and/or the computing system 228 may be implemented in any other suitable manner.

As shown in FIG. 3, the device 300 denotes a computing device or system that includes at least one processing device 302, at least one storage device 304, at least one communications unit 306, and at least one input/output (I/O) unit 308. The processing device 302 may execute instructions that can be loaded into a memory 310. The processing device 302 includes any suitable number(s) and type(s) of processors or other devices in any suitable arrangement. Example types of processing devices 302 include one or more microprocessors, microcontrollers, digital signal processors (DSPs), application-specific integrated circuits (ASICs), field programmable gate arrays (FPGAs), graphics processing units (GPUs), or discrete circuitry.

The memory 310 and a persistent storage 312 are examples of storage devices 304, which represent any structure(s) capable of storing and facilitating retrieval of information (such as data, program code, and/or other suitable information on a temporary or permanent basis). The memory 310 may represent a random-access memory or any other suitable volatile or non-volatile storage device(s). The persistent storage 312 may contain one or more components or devices supporting longer-term storage of data, such as a read only memory, hard drive, Flash memory, or optical disc.

The communications unit 306 supports communications with other systems or devices. For example, the communications unit 306 can include a network interface card or a wireless transceiver facilitating communications over a wired or wireless network. The communications unit 306 may support communications through any suitable physical or wireless communication link(s).

The I/O unit 308 allows for input and output of data. For example, the I/O unit 308 may provide a connection for user input through a keyboard, mouse, keypad, touchscreen, or other suitable input device. The I/O unit 308 may also send output to a display or other suitable output device. Note, however, that the I/O unit 308 may be omitted if the device 300 does not require local I/O, such as when the device 300 can be accessed remotely or operated autonomously.

Although FIG. 3 illustrates one example of a device 300 for a time-multiplexed multi-functional coherent optical transceiver 200, various changes may be made to FIG. 3. For example, computing devices and systems come in a wide variety of configurations, and FIG. 3 does not limit this disclosure to any particular computing device or system.

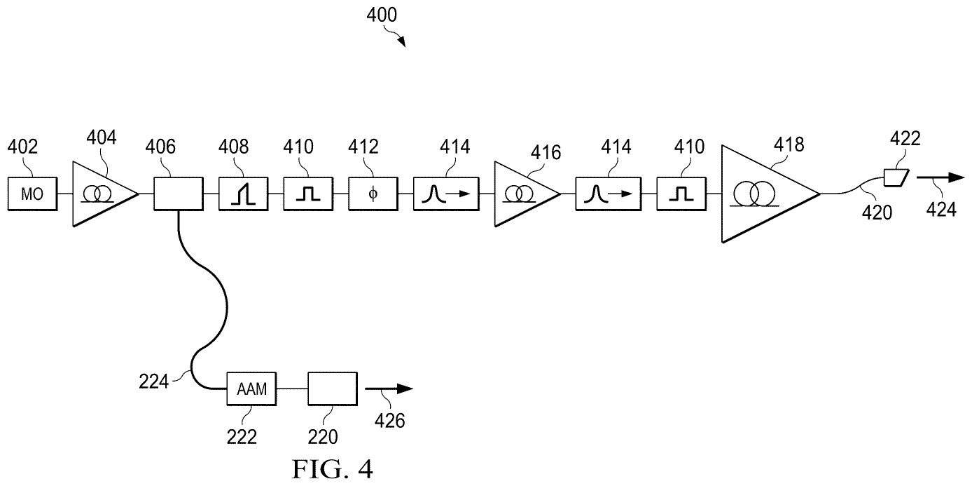

FIG. 4 illustrates an example schematic block diagram 400 of the fiber-laser transmitter 202 for supporting a time-multiplexed multi-functional coherent optical transceiver 200 in accordance with this disclosure. As shown in FIG. 4, the fiber-laser transmitter 202 includes a single-frequency optically-isolated fiber-coupled master oscillator (MO) 402, such as a distributed-feedback or distributed-Bragg-reflector diode or fiber laser. The master oscillator 402 is followed by a multi-stage rare-earth-doped fiber amplifier sequence including two or more stages of inter-stage fiber-coupled optical filters and isolators 414, such as Faraday isolators. In some embodiments, these components can be fiber-coupled and fusion-spliced or otherwise coupled to each other to form a continuous chain devoid of misalignment-prone free-space optical paths.

In example embodiments, the master oscillator 402 has an output fiber that is directly spliced to a fiber-optic sampler 406, such as a 10 dB tap coupler. The fiber-optic sampler 406 directs a fraction of the beam emitted by the master oscillator 402 into a secondary single-mode transport fiber to provide a continuous wave reference beam, which may be referred to as a local oscillator beam 426. In these embodiments, the local oscillator beam 426 exiting the fiber, which may represent the delivery fiber 224, can be directed to flood-illuminate the transceiver detector in order to support coherent detection as explained below.

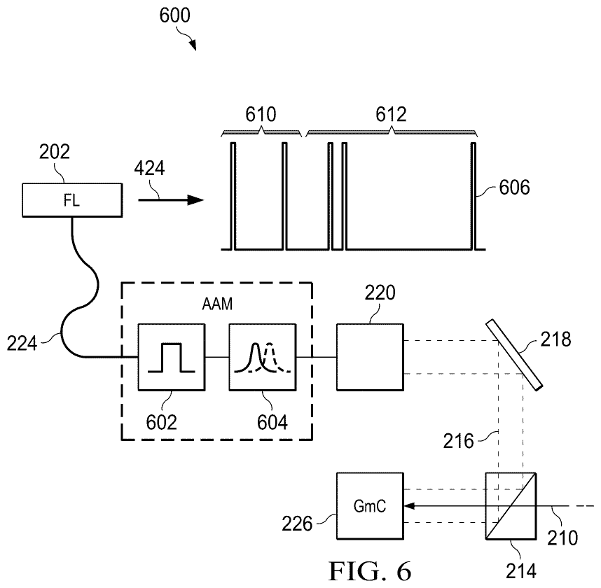

Because the local oscillator beam 426 is obtained from the master oscillator 402 itself, rather than from an external source, the type of coherent detection enabled is often referred to as self-homodyne or self-heterodyne (the latter definition applied to cases in which the local oscillator is frequency-shifted). Prior to exiting the fiber, the local oscillator beam 426 can pass through an all-fiber-based adaptive active modifier 222, which includes one or more active components tasked to judiciously alter one or more properties of the local oscillator beam 426 in ways that remove ambiguity from the interpretation of coherently-detected data. Examples of ambiguity that could be removed include the Doppler contribution hampering the reconstruction of atmospheric aberration. In some embodiments, the adaptive active modifier 222 may contain one or more acousto-optic frequency shifters, electro-optic amplitude modulators, electro-optic phase modulators, delay lines, or other components. The design and operation of an example adaptive active modifier 222 are described further regarding FIG. 6. Optionally, the local oscillator beam 426 may pass through the local oscillator expander 220, via a delivery fiber, before exiting into free space.

In some embodiments, the master oscillator 402 may emit optical continuous wave power of greater than 1 watt to offset insertion losses introduced by transmission through the adaptive active modifier 222. Also, in some embodiments, an optional continuous wave booster fiber amplifier 404 may be used to boost the power of the beam from the master oscillator 402 prior to extracting part of its emitted power to obtain the local oscillator beam.

In some embodiments, the wavelength or wavelengths of the master oscillator 402 can be selected based on application requirements, which can also drive the choice of rare-earth-doped fiber to be used in the transmitter amplifier chain. For example, the fiber may include doping with ytterbium (Yb), erbium (Er), thulium (Tm), and/or holmium (Ho) to achieve wavelength windows of about 1.02 μm to about 1.1 μm, about 1.53 μm to about 1.6 μm, about 1.9 μm to about 2.07 μm, and/or greater than 2.1 μm. Other wavelengths may be supported, such as via Raman shifting in silica-, germanosilicate-, or phosphosilicate-core fibers.

In some embodiments, the output from the master oscillator 402 is amplitude-modulated to produce optical pulses using an active pulse-amplitude modulator 408, such as a fiber-coupled electro-optic Mach-Zehnder modulator or acousto-optic modulator or semiconductor-optical amplifier in “switch” mode. In other embodiments, the master oscillator 402 itself may be operated in pulsed mode, such as through gain- or Q-switching or mode-locking. One or more additional amplitude modulators, such as an optional optical-amplitude modulator 410, can be added along the amplifier chain to increase the on/off pulse contrast. Also, in some embodiments, the fiber-laser transmitter 202 may include a fiber-coupled electro-optic phase modulator 412, which can be used to impart time-dependent optical-phase patterns onto the transmitter-emitted beam. Depending on the implementation, the electro-optic phase modulator 412 can be used along with or in lieu of the optional optical-amplitude modulators 410.

In particular embodiments, there may be a repeating series of optical-amplitude modulators 410 and isolators 414 following a preamplifier 416 for N iterations. Also, in particular embodiments, the fiber-laser transmitter 202 may be entirely constructed using single-transverse-mode and polarization maintaining fibers. Further, in particular embodiments, the fiber-laser transmitter 202 may end with a polarization-maintaining passive delivery fiber 420 of core diameter, which may be fusion-spliced or otherwise coupled to the output end of the last fiber amplifier 418, and a transmit beam 424 may pass through to an endcap 422 before being emitted into free space. In addition, in particular embodiments, the fiber-laser transmitter 202 may have an average output power in the range from about 10 W to about 100 W or more.

In some embodiments, the fiber-laser transmitter 202 is architected as a plurality of parallel fiber-amplifier chains, such as a plurality of active pulse-amplitude modulators 408, optical-amplitude modulators 410, electro-optic phase modulators 412, and isolators 414 in series on different fibers. The parallel components may be seeded by the same common front-end, such as at the fiber-optic sampler 406. This can allow the active pulse-amplitude modulators 408 and the optical-amplitude modulators 410 to be phase-locked to each other in a coherently-combined architecture, such as for the purpose of scaling-up the emitted pulse energy.

The output beam from the fiber-laser transmitter 202 can be spatially processed to prepare the beam for free-space propagation to the target. In some embodiments, components used for spatial processing of the output beam may include a diffraction-limited beam expander, one or more relay reflectors, and a telescope, which might all be arranged in a Coudé light path to a transmission window.

Although FIG. 4 illustrates one example of a schematic block diagram 400 of the fiber-laser transmitter 202 for supporting a time-multiplexed multi-functional coherent optical transceiver 200, various changes may be made to FIG. 4. For example, various components in FIG. 4 may be combined, further subdivided, replicated, omitted, or rearranged and additional components may be added according to particular needs.

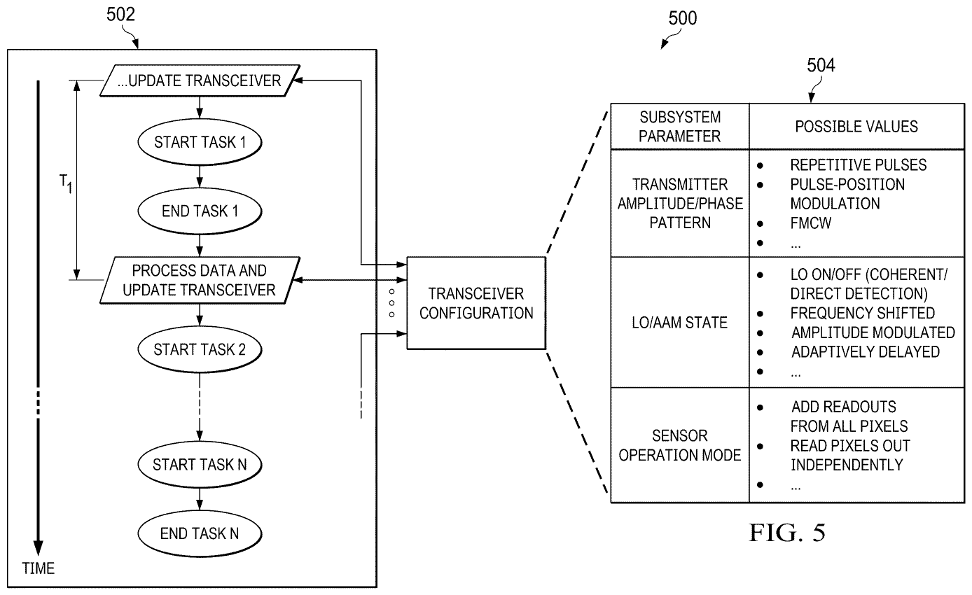

FIG. 5 illustrates an example mode of operation 500 for supporting a time-multiplexed multi-functional coherent optical transceiver 200 in accordance with this disclosure in accordance with this disclosure. For ease of explanation, the mode of operation 500 of FIG. 5 is described with respect to the architecture for the optical transceiver 200 of FIG. 2 being used in the system 100 of FIG. 1. However, the mode of operation 500 may be used in any other suitable device(s) and in any other suitable system(s).

As shown in FIG. 5, the optical transceiver 200 may follow an algorithm 502 that interleaves multiple operating modes, which are denoted by tasks. The tasks can incorporate processed data feedback, such as data from return beams 210, to update subsystem parameters 504 of the optical transceiver 200. More specifically, in this example, the optical transceiver 200 is used with the computing system 228 to perform different remote-sensing tasks within specifically-allotted and successive time intervals. These time intervals are such that tasks are interleaved in a rapid fashion, which yields a high refresh rate for the information that each task provides. In some embodiments, the duration and sequence of tasks are fixed, pre-determined, and hard-coded. In other embodiments, the duration and/or sequence of tasks can be modified adaptively, such as via commands imparted by an external operator or automatically (like through an objective-driven learning algorithm).

Information made available by completing each remote-sensing task may be used or leveraged in any suitable manner, such as to dynamically modify one or more relevant characteristics of the local oscillator 214 (including the timing and optical frequency of the local oscillator beam 216 from the local oscillator 214). Among other things, these dynamic modifications may reduce errors and ambiguities, such as from poor reconstruction of atmospheric aberration due to an unknown Doppler-shift contribution in an observed wavefront, in one or more subsequent remote-sensing tasks.

Although FIG. 5 illustrates one example of a mode of operation 500 for supporting a time-multiplexed multi-functional coherent optical transceiver 200, various changes may be made to FIG. 5. For example, computing devices and systems come in a wide variety of configurations, and FIG. 5 does not limit this disclosure to any particular computing device or system.

FIG. 6 illustrates an example portion 600 of a time-multiplexed multi-functional coherent optical transceiver 200 in accordance with this disclosure. As shown in FIG. 6, the fiber-laser transmitter 202, within an initial time interval 610, emits a stream of laser pulses each having duration and fixed pulse repetition frequency. During the initial time interval 610, the local oscillator 214 are turned off, which means that optical returns from the target are received directly (not through optical interference). In some embodiments, the sensor 226 is operated in a “single pixel” mode by adding together all pixel readouts, which maximizes signal collection at the expense of spatial resolution. In the initial time interval 610, the computing system 228 can determine a translational velocity of the target 208 by performing a range-rate measurement, which could include recording the times of arrival at the sensor 226 for a series of n consecutive return pulses, such as from the return beam 210 backscattered by the moving target 208. In some cases, the translational velocity ν of the target may be determined as follows.

$$𝓋 ∼ c ( 1 - \frac{2 n}{f Δ t} ) ,$$

Here, c is the speed of light, and Δt is the arrival-time difference between the first and n^{th} received return pulses.

In a subsequent time interval, such as a subsequent time interval 612, the operation of the fiber-laser transmitter 202 can be configured for digital holography. For example, the local oscillator 214 may be turned on to enable coherent detection, and each pixel of the sensor 226 may be read out independently to support spatial imaging. In some cases, the local oscillator 214 may not be used as-is but could be frequency-shifted to offset the Doppler effect caused by motion of the target. As a particular example, the offset frequency applied to the local oscillator 214 may be about equal in magnitude and opposite in sign with respect to the target Doppler shift and may be defined as follows.

$$Δ𝓋 ∼ \frac{2 𝓋}{λ} ,$$

Here, λ is the laser transmitter wavelength, and [symbol] is the value determined in the initial time interval 610. In some embodiments, the local oscillator 214 can be frequency-shifted by transmission through an electronically-controlled fiber-coupled acousto-optic variable frequency shifter (AOFS) 604, which could be spliced to the delivery fiber 224. In other embodiments, an AOFS 604 may be driven by a time-periodic linear voltage ramp, V(t). In some cases, the time-periodic linear voltage ramp may have the following form and interval.

$$V ( t ) ∼ 4 \frac{{𝓋V}_{π}}{λ} t$$

$$- \frac{λ}{4 𝓋} < t \leq \frac{λ}{4 𝓋} ,$$

$$V ( t + m \frac{λ}{2 𝓋} ) = V ( t ) , for any integer m .$$

Here, V_{π} is the voltage applied to the phase modulator to produce a phase shift equal to π. In some embodiments, a series of AOFSs 604, phase modulators 602, or a combination thereof can be used to address especially-large frequency shifts, such as those stemming from fast-moving targets. In typical embodiments as described above, the same transmitter performs both operations (range-rate measurements and atmospheric probing) thereby lifting the need for separate additional lasers acting as target-tracking and beacon illuminators and reducing size, weight, power, and cost.

In some embodiments using coherent detection pertaining to either the digital holography application addressed above or other applications, it may be necessary or desirable to switch the local oscillator 214 on only during short time intervals around the arrival of each return pulse in the return beam 210. This configuration may reduce or avoid saturating the sensor 226 with continuous wave light from the local oscillator 214 and may preserve its performance for detecting returns. To address arrival times of return pulses that are dependent on an unknown target range, the optical transceiver 200 may be configured to perform the following operations. In a first operation, during an initial time interval 610 with the local oscillator 214 switched off to enable direct detection, the fiber-laser transmitter 202 can be set to generate a non-periodic sequence of laser pulses 606, such as a pulse train in which the inter-pulse time intervals vary according to a pre-determined pattern. This allows each pulse to be distinct from the next, which makes it possible to have multiple pulses in flight to the target (boosting the detected signal without incurring range-measurement ambiguities).

In a second operation, the target range can be determined, such as using the computing system 228, based on the maximum of the cross-correlation between the series of pulse emissions and detected return arrival times of received pulses. In other words, the non-periodic sequence of laser pulses backscattered off the target 208 and received by the optical transceiver 200 may be correlated in order to identify the maximum cross-correlation. At the same time, velocity can be estimated, such as in a similar fashion via the cross-correlation of emitted and received inter-pulse time intervals. The range information obtained during the initial time interval 610 can be used in subsequent time intervals 612 to switch on the local oscillator 214 only during expected arrivals of return pulses, which can increase or maximize the detection performance of the sensor 226. In particular embodiments, this is implemented by transmitting the local oscillator beam 216 through a fiber-coupled electro-optic amplitude modulator 602, such as a Mach-Zehnder modulator, driven by a voltage signal that encodes the timing of returns computed from the range measurement in the initial time interval 610. In other words, the electro-optic amplitude modulator 602 transmits only when return pulses are expected to be present. In some cases, the electro-optic amplitude modulator 602 is fusion-spliced or otherwise coupled to the input or output end of the AOFS 604 described above.

In embodiments in which the fiber-laser transmitter 202 continually emits about 1 ns-wide laser pulses 606 temporally distributed according to a pulse-position-modulation pattern and having variable inter-pulse interval of less than 1 μs, such as corresponding to pulse emission rates greater than 1 MHz, the initial time interval 610 may be about 10 μs. Thus, in this time interval, the sensor 226 can be operated as a single-pixel detector and receive over ten return beam 210 pulses, which can be used to directly detect the target range and line-of-sight velocity. Subsequent time intervals may be assumed to be about 100 μs in length each, meaning greater than 100 returns can be detected coherently with the local oscillator 214 switched on and properly pulsed and frequency-switched as detailed above. Those returns can be processed to reconstruct atmospheric aberration via digital holography or to perform other functions. These detection tasks can be repeated, such as by being interleaved through the same timing arrangement, for an arbitrarily long observation time that, in the case of directed-energy weapon systems, may typically correspond to the dwell time of a high-energy laser on a target. Throughout this dwell time and according to the timing described above, the reconstruction of the atmosphere-induced aberration may be updated, for example, about every 110 μs corresponding to an effective refresh rate of about 9 kHz. As such, the optical transceiver 200 may finely resolve the time-evolution of atmospheric effects. Alternatively, the time intervals (such as the initial time interval 610 and the subsequent time intervals 612) may be shorter due to, for example, higher laser-transmitter power at a given range, increasing the processing speed.

Although FIG. 6 illustrates one example of a portion 600 of a time-multiplexed multi-functional coherent optical transceiver 200, various changes may be made to FIG. 6. For example, computing devices and systems come in a wide variety of configurations, and FIG. 6 does not limit this disclosure to any particular computing device or system.

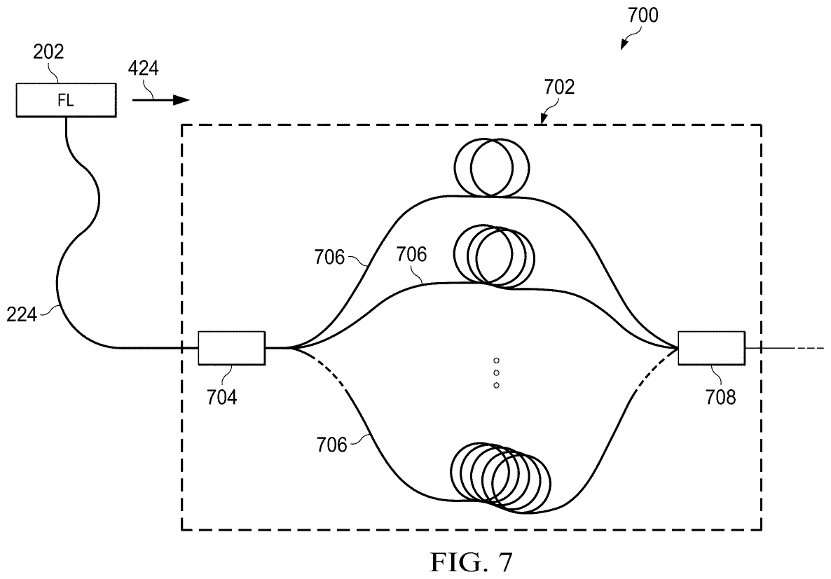

FIG. 7 illustrates an example portion 700 of a time-multiplexed multi-functional coherent optical transceiver 200 in accordance with this disclosure. As shown in FIG. 7, the fiber-laser transmitter 202 is configured to perform FMCW LIDAR. As explained above, in longer-range applications, FMCW LIDAR typically poses stringent coherence-length requirements that are difficult to meet using laser transmitters. The present disclosure offers a way to relax these requirements and leverage the disclosed time-multiplexed detection approaches.

As shown FIG. 7, the fiber-laser transmitter 202 is configured to operate as a direct detector (with the local oscillator turned off) during the initial time interval 610 in which the target range is measured as described above. Namely, the fiber-laser transmitter 202 emits a pulse-position-modulated sequence of laser pulses, and returns are processed (such as through a cross-correlation algorithm). Once the range is acquired, in a subsequent time interval 612, the fiber-laser transmitter 202 switches to FMCW mode. In this mode, the fiber-laser transmitter 202 emits a frequency-modulated continuous wave transmit beam 424, and the local oscillator is turned on to enable coherent detection. However, prior to reaching the sensor 226, the local oscillator beam passes through an all-fiber adaptive delay network (ADN) 702, which in some cases may be fusion spliced or otherwise coupled to the delivery fiber 224.

In this example, the ADN 702 includes an active one-to-N fiber-optic switch 704, which includes a common input port, an array of N output ports, and an electronically-controlled electro-optic or micro-electro-mechanical apparatus (not shown) that directs light from the common port into a selected output port. Each output port of the fiber-optic switch 704 may be fusion-spliced or otherwise coupled to one or more fiber-optic delay lines 706 of distinct length [symbol] ⱼ (where j=1, . . . , N). The output ends of the fiber-optic delay lines 706 are combined back into a single fiber through a passive fiber-optic combiner 708. In some embodiments, the fiber-optic delay lines 706 represent densely-spooled stretches of optical transport fiber having [symbol] ⱼ ranging from several kilometers to several tens of kilometers. The fiber-optic delay lines 706 may be low-cost and compactly-sized fiber reels and could exhibit low optical loss (such as about 0.3 dB/km or less).

One example benefit of using the ADN 702 stems from both the local oscillator and transmit beams originating from the same master oscillator 402, thus sharing the same optical phase evolution pattern including random phase jumps. The fiber-optic delay lines 706 effectively reduce the path-length difference between the local oscillator and transmit beams, thereby relaxing the laser coherence-length and corresponding optical-linewidth requirements for the fiber-laser transmitter 202. For example, the transmitter linewidth λν in FMCW LIDAR may satisfy the following condition.

$$Δ𝓋 < \frac{{σ}_{φ}}{2 π} \frac{c}{2 R - n ℓ}$$

Here, σ_{φ} is a tolerable phase error (such as less than π/10), c is the speed of light, R is the target distance of the fiber-laser transmitter 202, n is the refractive index of the core in fused-silica fibers (such as about 1.45), and [symbol] is the length of the delay line in the ADN 702. Without ADN 702 (such as [symbol] =0) and for typical operation parameters (such as R=about 10 km and σ_{φ}=about π/30), Av is about 250 Hz, which corresponds to a very narrow spectral linewidth that exceeds specifications of many commercial lasers. The ADN 702 can therefore function to select, based on the value of R measured by direct detection during the time interval T₁, a delay line having [symbol] such that the quantity (2R−n [symbol] ) is reduced or minimized while remaining positive.

Although FIG. 7 illustrates one example of a portion 700 of a time-multiplexed multi-functional coherent optical transceiver 200, various changes may be made to FIG. 7. For example, computing devices and systems come in a wide variety of configurations, and FIG. 7 does not limit this disclosure to any particular computing device or system.

In some embodiments, various functions described in this disclosure are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this disclosure. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of the disclosed subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An optical transceiver comprising:
a fiber-laser transmitter configured to transmit a transmit beam toward a target;
transmitter optics optically coupled to the fiber-laser transmitter;
an optical receiver configured to receive a return beam;
an adaptive active modifier optically coupled to the optical receiver;
a local oscillator optically coupled to the optical receiver and the adaptive active modifier; and
at least one processing device coupled to the fiber-laser transmitter and the adaptive active modifier, the at least one processing device configured to cause the optical transceiver to turn off the local oscillator during an initial time interval, emit a stream of laser pulses using the fiber-laser transmitter during the initial time interval toward the target, measure the return beam, and determine a translational velocity of the target.

2. The optical transceiver of claim 1, wherein the at least one processing device is further configured to cause the optical transceiver, after determining the translational velocity of the target during the initial time interval, to turn on and frequency-shift the local oscillator using an offset frequency equal to a Doppler shift of the target for a subsequent time interval.

3. The optical transceiver of claim 1, wherein the optical receiver comprises a sensor and wherein the at least one processing device is further configured, after determining the translational velocity of the target during the initial time interval, to generate spatial imaging for a subsequent time interval using the sensor.

4. The optical transceiver of claim 1, wherein the at least one processing device is further configured to cause the optical transceiver to transmit a non-periodic sequence of laser pulses using the fiber-laser transmitter during the initial time interval, determine a target range using a maximum of a cross-correlation between the non-periodic sequence of laser pulses and detected return arrival times of received pulses, and use the determined target range to determine a duration to have the local oscillator turned on.

5. The optical transceiver of claim 4, wherein the at least one processing device is further configured to use the determined target range to determine a timing of an emission of a local oscillator beam from the local oscillator to the optical receiver.

6. The optical transceiver of claim 1, wherein the sensor comprises an array of Geiger-mode avalanche photodiodes configured to timestamp each light detection event.

7. The optical transceiver of claim 1, wherein the adaptive active modifier comprises an acousto-optic variable frequency shifter and an electro-optic phase modulator.

8. A system comprising:
a high-energy laser system; and
an optical transceiver disposed within the high-energy laser system, the optical transceiver comprising:
a fiber-laser transmitter configured to transmit a transmit beam toward a target;
transmitter optics optically coupled to the fiber-laser transmitter;
an optical receiver configured to receive a return beam;
an adaptive active modifier optically coupled to the optical receiver;
a local oscillator optically coupled to the optical receiver, the adaptive active modifier, and the sensor; and
at least one processing device coupled to the fiber-laser transmitter and the adaptive active modifier, the at least one processing device configured to cause the optical transceiver to turn off the local oscillator during an initial time interval, emit a stream of laser pulses using the fiber-laser transmitter during the initial time interval toward the target, measure the return beam, and determine a translational velocity of the target.

9. The system of claim 8, wherein the at least one processing device is further configured to cause the optical transceiver, after determining the translational velocity of the target during the initial time interval, to turn on and frequency-shift the local oscillator using an offset frequency equal to a Doppler shift of the target for a subsequent time interval.

10. The system of claim 8, wherein the optical receiver comprises a sensor and wherein the at least one processing device is further configured, after determining the translational velocity of the target during the initial time interval, to generate spatial imaging for a subsequent time interval using the sensor.

11. The system of claim 8, wherein the at least one processing device is further configured to cause the optical transceiver to transmit a non-periodic sequence of laser pulses using the fiber-laser transmitter during the initial time interval, determine a target range using a maximum of a cross-correlation between the non-periodic sequence of laser pulses and detected return arrival times of received pulses, and use the determined target range to determine a duration to have the local oscillator turned on.

12. The system of claim 11, wherein the at least one processing device is further configured to use the determined target range to determine a timing of an emission of a local oscillator beam from the local oscillator to the optical receiver.

13. The system of claim 8, wherein the sensor comprises an array of Geiger-mode avalanche photodiodes configured to timestamp each light detection event.

14. The system of claim 8, wherein the adaptive active modifier comprises an acousto-optic variable frequency shifter and an electro-optic phase modulator.

15. A method comprising:
initiating a first task in a first mode for an initial time interval using at least one processing device coupled to an optical transceiver, the optical transceiver comprising:
a fiber-laser transmitter configured to transmit a transmit beam toward a target;
transmitter optics optically coupled to the fiber-laser transmitter;
an optical receiver configured to receive a return beam;
an adaptive active modifier optically coupled to the optical receiver; and
local oscillator optically coupled to the optical receiver and the adaptive active modifier; and
initiating a second task in a second mode for a subsequent time interval using the optical transceiver.

16. The method of claim 15, wherein initiating the first task in the first mode for the initial time interval comprises:
turning off the local oscillator during the initial time interval;
emitting a stream of laser pulses using the fiber-laser transmitter during the initial time interval toward the target;
measuring a return beam; and
determining a translational velocity of the target based on the return beam.

17. The method of claim 16, wherein initiating the second task in the second mode for the subsequent time interval comprises:
after determining the translational velocity of the target during the initial time interval, turning on and frequency-shifting the local oscillator using an offset frequency equal to a Doppler shift of the target for the subsequent time interval.

18. The method of claim 15, wherein initiating the second task in the second mode for the subsequent time interval comprises:
generating spatial imaging.

19. The method of claim 15, further comprising:
generating a non-periodic sequence of laser pulses using the fiber-laser transmitter during the initial time interval;
determining a target range using a maximum of a cross-correlation between the non-periodic sequence of laser pulses and detected return arrival times of received pulses; and
using the determined target range to determine a duration to have the local oscillator turned on.

20. The method of claim 19, further comprising:
using the determined target range to determine a timing of an emission of a local oscillator beam from the local oscillator to the optical receiver.
